(19) United States
(12) Patent Application Publication
(10) Pub. No.: US 2025/0124523 A1
(43) Pub. Date: Apr. 17, 2025

(54) DECENTRALIZED APPLICATION FEATURE BASED SOCIAL NETWORK

(71) Applicant: Sony Interactive Entertainment Inc., Tokyo (JP)

(72) Inventor: Charlie Dension, Piedmont, CA (US)

(21) Appl. No.: 18/484,786

(22) Filed: Oct. 11, 2023

(51) Int. Cl. G06Q 50/00; G06F 16/953

(52) U.S. Cl. CPC G06Q 50/01; G06F 16/953

(57) ABSTRACT

A method, system and computer program product for implementing a decentralized application feature based social network with a device, comprising generating a feature page for a feature of an application with application data and updating feature page with feature information. User comment data is the received and the feature page is updated with the user comment data. Finally the feature page is displayed including feature information and user comment data

### FIELD OF THE DISCLOSURE

Aspects of the present disclosure relate to networking specifically aspects of the present disclosure relate to the creation of a decentralized social network.

### BACKGROUND OF THE DISCLOSURE

Applications commonly have help files that provide information about features of the application that the user may want to know. Some applications such as games may have help files that include a compendium of application features that the user can search through. Here application features may include application mechanics, application assets, application levels, application maps, application lore, application sounds, application music etc.

Social networks are common in today's society and guide the way people interact with each other. Users of social networks may flock to social networks to discuss using applications such as games, media, news readers, etc. These social networks are not integrally tied to the applications in a meaningful way. Instead, applications may include links to the social network platform. Social networks may have pages created for the application by the users and maintained by the users, developers may assist in the creation of social network pages by providing assets or creating social network pages themselves. This creates quite a burden for the users as they must find and/or maintain separate social pages for the application. Additionally, because the social pages are separate from the application developers and individual users have little to no control over the information that is disclosed on those social pages.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a flow diagram showing a method for implementing a decentralized application feature based social network according to aspects of the present disclosure.

FIG. 2 is a pictorial diagram depicting decentralized information sharing for the application based social network according to aspects of the present disclosure.

FIG. 3 is a diagram depicting an implementation of an application feature page according to aspects of the present disclosure.

FIG. 4 is a diagram depicting an implementation of an application feature page including video help pages according to aspects of the present disclosure.

FIG. 5 is a system diagram showing a system implementing the method for implementing a decentralized application feature based social network according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claims.

Social networks such as Twitter, Facebook, and Reddit exist as separate entities that users visit to discuss news, events, and applications. These existing social networks serve users with information created by other users from their own separate servers. This information is only available on the social network-controlled pages and only maintained by the social network. This independent control of user-created information makes integration with applications to provide a seamless experience currently not possible without also integration of the entire social network platform into the application. This may go against the wishes of application developers and may also go against the terms of service of the social network. Thus, to integrate social networking with applications a different kind of social networking system may be required. Thus, according to aspects of the present disclosure a decentralized social networking protocol may be used with application information to generate a device that integrates information about the application with social commentary. This may provide the user with a seamlessly integrated experience with applications allowing help files to show comments by other users in the application or in an overlay on top of the application.

By way of example, and not by way of limitation, ActivityPub, developed by the World Wide Web Consortium is an open, decentralized social networking protocol that provides a client/server API for creating, updating, and deleting content, as well as a federated server-to-server API for delivering notifications and content.

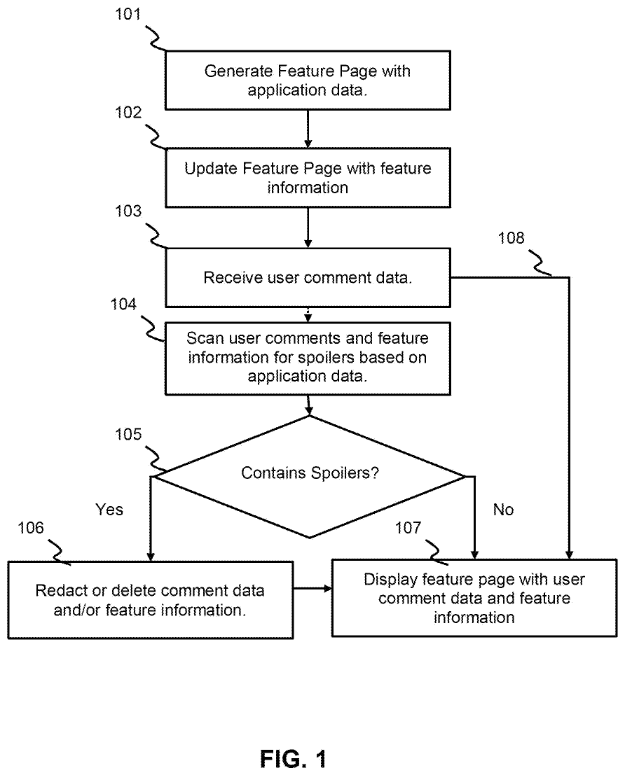

FIG. 1 is a flow diagram showing a method for implementing a decentralized application feature based social network according to aspects of the present disclosure. Applications typically include a corpus of feature information about the application such as help files, compendiums, or other information collections about the applications. Alternatively, this corpus of feature information may be stored in a separate database either locally or on a server connected to the device through a network. The device may initially scan the corpus of information about the application and generate application feature pages for each entry in the corpus using application data and optionally the corpus of information about the application, as indicated at 101. In some alternative implementations the device may generate application feature pages using application data on the fly when viewed by a user. Once a feature page has been generated the device may update the feature page with feature information from the corpus of feature information, as indicated at 102. The device may send a request to a remote server storing the corpus of application feature information or may request the information from an internal database. The server or internal database may send the information to the device upon receipt of the request and once receive the feature information may be used to update the feature page. In some alternative implementations the device may pull application data from the memory or from a remote server, for example and without limitation the device may take application data such as application assets (e.g., 3d models, sprites, etc.) and use the application on a feature page.

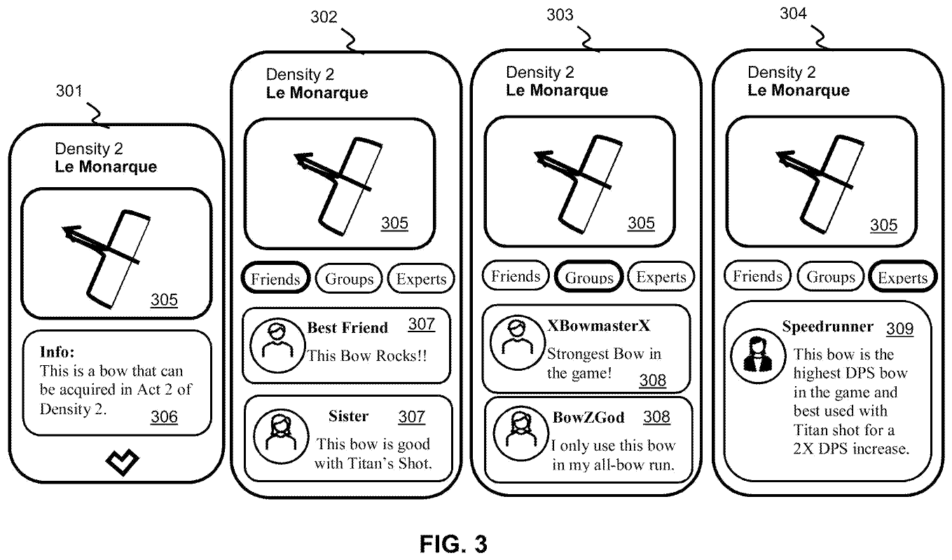

FIG. 3 provides a diagram depicting an implementation of an application feature page according to aspects of the present disclosure. As shown a first feature page 301 may include title/name of the feature, a rendering window 305 which may render application assets or images from the corpus of feature information and an information window. Feature information may be used to update the feature information window 306 which is configured to display text about the feature.

Turning back to FIG. 1 once the feature page is updated with the feature information, the device may request user comment data about the feature from a social networking server. User comment data includes text strings corresponding to comments made by other users of the application in the social network and may also include hyperlinks, images, video, and emoji. The device may request user comment data based on a list of friends of the user, groups the user belongs to, influencers/experts the user follows. Limiting the social network information requests in this way allows the user to curate a better social experience. In some alternative implementations the device may request all social networking interactions associated with the feature. In response the server may send the requested user comment data to the device. The device then receives the requested user comment data at 103. The device may then update the feature page with the user comment data 108 and then may cause a display to show the feature page with the user comment data and feature information 107. Display of the feature page may be handled by within the application (i.e., the application for which the feature page with the application have been generated) or by another program or service or operating system running in the background of the application. The feature page may be displayed within the application. For example, the application may have dedicated programming for display of the feature page. Alternatively, an overlay may be used to display feature pages on top of screens from the application or a separate window containing the feature page may open simultaneously with the application.

Referring again to FIG. 3 in some implementations, the feature page may have multiple tabs displaying different information about the feature to the user. The first feature tab 301 may be the information tab, this tab provides information about the feature entered by the application developer, the second feature tab 302 may be the friends tab and includes comments from the friends and/or family of the user 307. The third feature tab 303 may be the groups tab, this tab may include comments made by members of one or more groups 308 to which the user has subscribed. The fourth feature tab 304 may be the experts/influencers tab, this tab provides comments from experts and/or influencers 309 subscribed to by the user.

In some alternative implementations a spoilers module may be implemented to remove spoilers from the feature information and/or the user comment data. The spoilers module of the device may scan the user comment data and/or feature information with the spoilers module 104. The spoilers module may use application data to determine progression points of the user in the application. The application data may be for example and without limitation, application states and information indicative of an application. From the application state a progress point may be determined. For example, and without limitation, the application may be a game, game states may be used to determine progress in the game as games are generally linear or semi-linear, the corpus of feature information may include a timeline of progress points. Progress points may track when a character reaches a particular level, location, item, dialogue, trigger etc. When the player has reached a progress point the user tracking portion of a database of feature information may be updated. From progress points and the feature information, the device may determine features and feature information that the user has not yet seen, e.g., from progress points that the user has not yet reached. These features and feature information not yet seen by the user are spoilers. The feature information and user comment data may be searched for key words or phrases related to spoilers during scanning. In some alternative implementations a neural network model may be trained with a machine learning algorithm to detect words or phrases associated with spoilers. The trained neural network model may be for example and without limitation a pretrained a large language model, or similar, customized to detect words or phrases associated with spoilers. Some example pre-trained large language models are Generative pretrained transformers (GPT) models, Bidirectional Encoder Representations from Transformers (BERT) models, Text to Text transfer transformer (T5), etc.

During or after scanning for spoilers the system determines which comments, and/or feature information contain spoilers 105. In some implementations the system may determine which portions of comments and/or feature information include spoilers.

When the system determines that a comment or feature information contains a spoiler the system may redact or delete the comment the comment of feature information containing the spoiler 106. In some implementations the redaction may be removable by the user for example and without limitation the redaction may be a black bar that says spoilers in white letter and when clicked reveals the hidden information. Once the spoilers are removed or redacted the device may cause the feature page to be displayed 107.

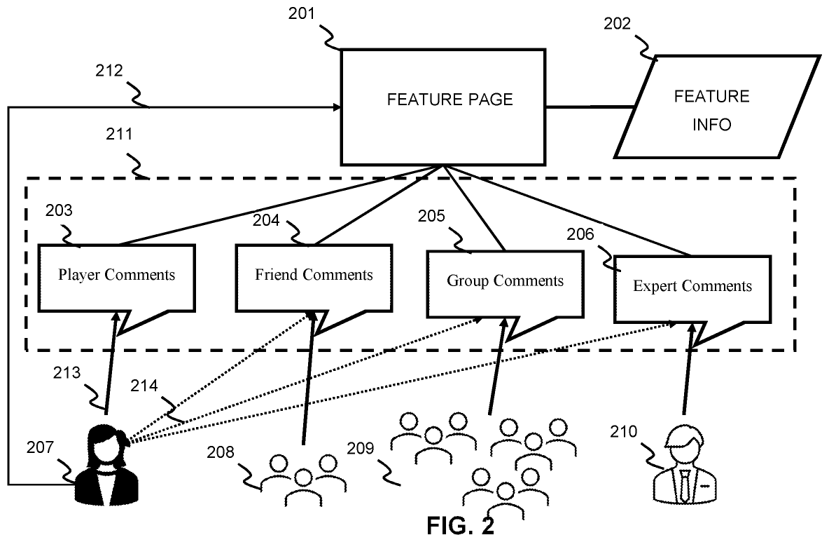

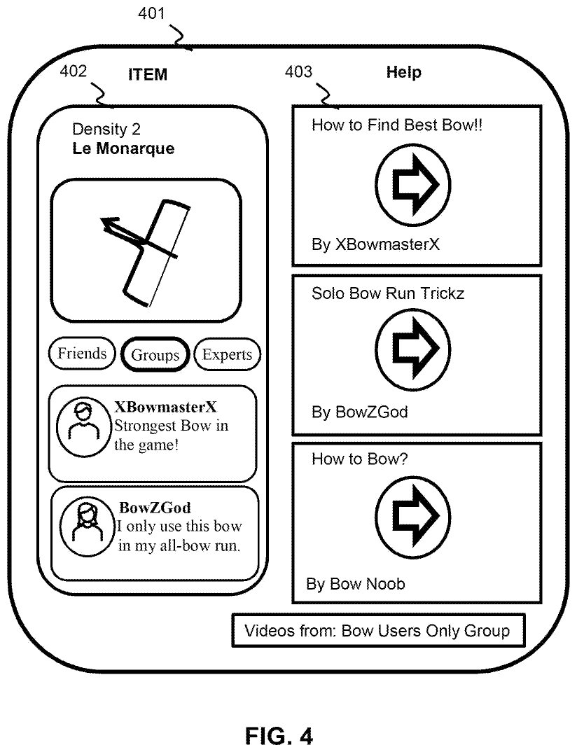

FIG. 2 is a pictorial diagram depicting decentralized information sharing for the application based social network according to aspects of the present disclosure. As shown game feature pages 201 are tied to a database containing a corpus of feature information 202. The game features feature page may be an informational page such as the ones shown in FIG. 3 of FIG. 4. Comment data from individual players 203 are published to the social networking server 211 which stores the comment data indexed by user profile, the user of the device 207 may be one such individual player. When the user of the device 207 makes a comment using the device it is published 213 to the social networking server 211. The user of the device may also subscribe 214 to various relations of comments to the user, for example friends' comments 204, group comments 205 and expert/influencer comments 206. These different types of comments are made by individuals defined by relation to the user of the device. Thus, the networking server stores various relation types between the user profile of the device and other user profiles or groups of user profiles. Alternatively, the device may store various relation types between the user profile of the device and other user profiles or groups of user profiles. The device may request comment data from profiles based on the stored relation. In yet another alternative implementation a combination of the server and the device may store user relations for example and without limitation the friends of the user may be stored on the device and membership within a group (e.g., group member lists) may be stored on the server, the device may simply store that the user part of a particular group. As such, when the user of the device defines another user as a friend, the two users are placed in the friend relationship category 208 and the user subscribes to comments from the friended profile under the friends tab. When the user of the device 207 views 212 a feature page, the device downloads comments associated with the application feature made by friends. In some implementations, this may be implemented in a peer-to-peer type network or, alternatively, the comments may be stored on a cloud server.

Similarly, the user may join a group of user profiles 209 by joining the group the user subscribes 214 to comments that are published by other profiles that share the group membership 209. When the user accesses the feature page, comment data published by user profiles that share group membership with the user may be downloaded and displayed on the group tab of the feature page. Finally, the user may choose to subscribe to comments by Experts/influencers 206. Whereas the friendship relation may require both the user of the device and the other user to accept each other as friends, Expert/influencer comments are one sided meaning the user of the device will see the expert/influencer comments but the expert/influencer 210 does not have to accept the friendship of the user of the device 207. The expert/influencer may have a profile type that presents them as a public facing profile allowing them to publish comment data other users may subscribe to without adding them to the friend's relation. Additionally, the user of the device may also select to unsubscribe from individual user comments, or group comments or group member comments, without removing the offending individual user from the friend relation or the leaving the group.

While the aspects of the present disclosure discuss storing the relations between the user of the device and friends, groups and experts in the social networking server, aspects of the present disclosure are not so limited, relations of the user may be stored on the device or in a separate profile server. This implementation may allow for greater flexibility as the relation between users does not need to be localized to a single repository.

FIG. 4 depicts an implementation of an application feature page including video help pages according to aspects of the present disclosure. In this implementation user comment data are not limited to text. As shown the feature page 401 may include a section for application feature information 402 and a section for videos 403 related to the application feature. The videos may be published to the social networking server by other users who have a relational tie to the user of the device (e.g., friends, group members, experts, etc.). The Videos may be organized by relation of the creator to the user of the device and videos related to a selected feature page tab may be displayed concurrently with comments from the particular relation. For example, and without limitation, as shown, when the group comments feature page tab is selected, comment data published by group members are displayed concurrently with videos published by group members. The feature page may include video decoding and playback capabilities using any suitable video decoding and streaming methods, for example and without limitation HTTP Live streaming (HLS) with H.264 video format and mp3 audio.

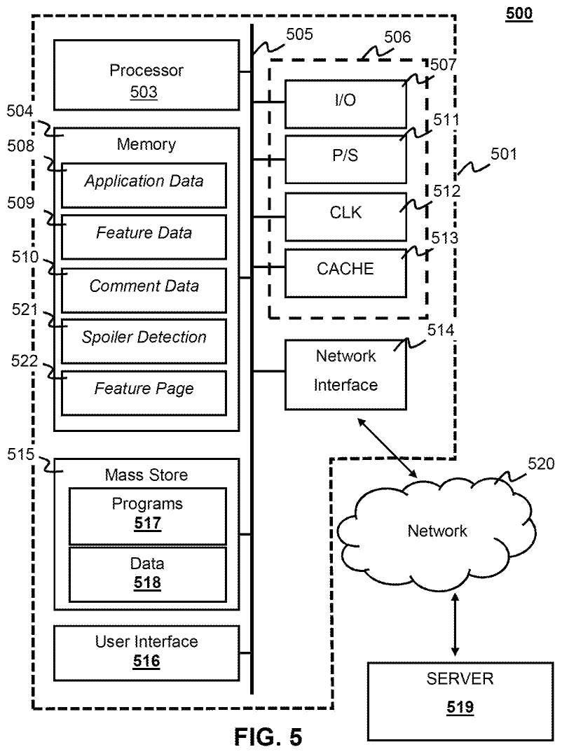

FIG. 5 is a system diagram showing a system implementing the method for implementing a decentralized application feature based social network according to aspects of the present disclosure. The computing device 501 may include one or more processor units and/or one or more graphical processing units (GPU) 503, which may be configured according to well-known architectures, such as, e.g., single-core, dual-core, quad-core, multi-core, processor-coprocessor, cell processor, and the like. The computing device may also include one or more memory units 504 (e.g., random access memory (RAM), static random-access memory (SRAM), dynamic random-access memory (DRAM), read-only memory (ROM), and the like). The computing device may optionally include a mass storage device 515 such as a disk drive, CD-ROM drive, tape drive, flash memory, solid state drive (SSD) or the like, and the mass storage device may store programs and/or data. The processor unit 503 may execute one or more programs, portions of which may be stored in memory 504 and the processor 503 may be operatively coupled to the memory, e.g., by accessing the memory via a data bus 505. The programs may be configured to implement a method for a decentralized application feature based social network as described above, for example in FIG. 1, to generate one or more feature pages 522 with application data 508. These programs may be part of the platform's operating system or part of an application or may be standalone programs or services running independently of the application. The memory may include data utilized by the operating system or programs carrying out the method for a decentralized application feature based social network such as information corresponding to feature data 509 about features of the application, application data 508, user comment data 510, e.g., comments published by the user or comments from other users of the social network. Additionally, the memory 504 may include one or more spoiler detection modules 521 the spoiler detection module may search user comment data and/or feature information for spoilers and may include one or more neural networks or other machine learning models trained with a machine learning algorithm to detect spoilers. The neural network model may be a pre-trained model customized for spoiler detection for example and without limitation Generative pre-trained transformers (GPT) models, Bidirectional Encoder Representations from Transformers (BERT) models, Text to Text transfer transformer (T5), etc. The information and/or programs stored in memory 504 may also be stored in the mass storage device 515 as programs 517 and/or data 518. Alternatively, this information may be stored on a non-transitory computer readable medium as instructions for the system to carry out the method for a decentralized application feature based social network, e.g., as described above with respect to FIG. 1.

The computing device 501 may also include well-known support circuits, such as input/output (I/O) 507, circuits, power supplies (P/S) 511, a clock (CLK) 512, and cache 513, which may communicate with other components of the system, e.g., via the data bus 505. The computing device may include a network interface 514 to facilitate communication with other devices. The processor 503 and network interface 514 may be configured to implement a local area network (LAN), personal area network (PAN), Wide area network (WAN), and/or communicate with the internet, via a suitable network protocol, e.g., Bluetooth, for a PAN. The computing device 501 may also include a user interface 516 to facilitate interaction between the system and a user. The user interface may include a display screen, a keyboard, a mouse, microphone, a light source and light sensor or camera, a touch interface, game controller, or other input device.

The network interface 514 facilitates communication via an electronic communications network 550. The network interface 514 may be configured to facilitate wired or wireless communication over LAN, PAN, and/or the internet with a remote server 519. The server may be a social networking server and/or a feature information server. The system 500 may send and receive data and/or commands via one or more message packets over the network 520. Message packets sent over the network 520 may temporarily be stored in a buffer in memory 504.

According to aspects of the present disclosure a seamlessly integrated social networking experience based on application features may be created allowing help files to show comments by other users in the application or in an overlay on top of the application. This beneficially allows application developers to have control over what information the user views, and provides an outlet for other users to comment on the application feature.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A,” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for implementing a decentralized application feature based social network with a device, comprising:
a) generating a feature page for a feature of an application with application data;
b) updating feature page with feature information;
c) receiving user comment data and updating the feature page with the user comment data;
d) display feature page including feature information and user comment data.

2. The method of claim 1 wherein b) further comprises scanning the feature information with a spoilers module and redacting feature information that contains spoilers from the feature information when the spoilers module detects spoiler information in the feature information.

3. The method of claim 1 wherein c) further comprises scanning the user comment data with a spoilers module and redacting user comment data that contain spoilers from the user comment data when the spoilers module detects spoiler information in the user comment data.

4. The method of claim 1 wherein the d) further comprises displaying a feature page having at least one of redacted feature information and redacted user comment data, wherein at least one of the feature information and user comment information are scanned with for spoilers by a spoilers module.

5. The method of claim 4 wherein the spoilers module includes a neural network trained with a machine learning algorithm to detect words are phrases associated with a progression point in the application data not yet achieved by the user.

6. The method of claim 4 wherein the feature information tracks progression points not achieved by the user and further comprising searching for key words the comment data associated with the progression points not yet achieved by the user.

7. The method of claim 4 wherein the application data tracks progression points not yet achieved by the user and further comprising searching for key words in at least one of the comment data and the feature information associated with the progression points not yet achieved by the user.

8. The method of claim 1 wherein updating the feature page with feature information includes receiving one or more videos associated with the feature information.

9. The method of claim 1 wherein updating the feature page with feature information includes requesting the feature information from a feature information database.

10. The method of claim 9 wherein the feature information database is a remote feature information database server.

11. The method of claim 9 wherein the feature information database is stored in a memory on the device.

12. The method of claim 1 wherein receiving user comment data and updating the feature page with the user comment data includes receiving at least one of video and images associated with the feature of the application.

13. The method of claim 1 wherein the user comment data includes social media activity from at least one of friends, social group members, and experts.

14. The method of claim 1 wherein the user comment data is stored in a memory on the device after being received.

15. A system for implementing a decentralized application feature based social network, comprising:
a processor;
a memory coupled to the processor;
non-transitory instructions embodied in the memory that when executed by the processor cause the processor to carry out the method comprising:
a) generating a feature page for a feature of an application with application data;
b) updating feature page with feature information;
c) receiving user comment data and updating the feature page with the user comment data;
d) display feature page including feature information and user comment data.

16. The system of claim 15 wherein b) further comprises scanning the feature information with a spoilers module and redacting feature information that contains spoilers from the feature information when the spoilers module detects spoiler information in the feature information.

17. The system of claim 15 wherein c) further comprises scanning the user comment data with a spoilers module and redacting user comment data that contain spoilers from the user comment data when the spoilers module detects spoiler information in the user comment data.

18. The system of claim 15 wherein the d) further comprises displaying a feature page having at least one of redacted feature information and redacted user comment data, wherein at least one of the feature information and user comment information are scanned with for spoilers by a spoilers module.

19. The system of claim 18 wherein the spoilers module includes a neural network trained with a machine learning algorithm to detect words are phrases associated with a progression point in the application data not yet achieved by the user.

20. The system of claim 18 wherein the feature information tracks progression points not achieved by the user and further comprising searching for key words the comment data associated with the progression points not yet achieved by the user.

21. The system of claim 18 wherein the application data tracks progression points not achieved by the user and further comprising searching for key words in at least one of the comment data and the feature information associated with the progression points not yet achieved by the user.

22. The system of claim 15 wherein updating the feature page with feature information includes receiving one or more videos associated with the feature information.

23. The system of claim 15 wherein updating the feature page with feature information includes requesting the feature information from a feature information database.

24. The system of claim 23 wherein the feature information database is a remote feature information database server.

25. The system of claim 23 wherein the feature information database is stored in the memory.

26. The system of claim 15 wherein receiving user comment data and updating the feature page with the user comment data includes receiving at least one of video and images associated with the feature of the application.

27. The system of claim 15 wherein the user comment data includes social media activity from at least one of friends, social group members, and experts.

28. The system of claim 15 wherein the user comment data is stored in the memory after being received.

29. A non-transitory computer readable medium having computer executable instructions embodied thereon, the instructions when executed cause the computer to carry out a method for implementing a decentralized application feature based social network with the computer comprising:
a) generating a feature page for a feature of an application with application data;
b) updating feature page with feature information;
c) receiving user comment data and updating the feature page with the user comment data;
d) display feature page including feature information and user comment data.
